(19) United States
(12) Patent Application Publication
(10) Pub. No.: US 2022/0396193 A1
(43) Pub. Date: Dec. 15, 2022

(54) SERVICE CARTS FOR FOOD, BEVERAGE, AND OTHER APPLICATIONS

(71) Applicant: Carts of Colorado, Inc., Denver, CO (US)

(72) Inventor: Dan GALLERY, Denver, CO (US)

(21) Appl. No.: 17/806,897

(22) Filed: Jun. 14, 2022

Related U.S. Application Data
(60) Provisional application No. 63/210,273, filed on Jun. 14, 2021.

(51) Int. Cl. B60P 3/025; B60L 1/00; B60R 16/033; B60L 50/60

(52) U.S. Cl. CPC B60P 3/0257; B60L 1/00; B60R 16/033; B60L 50/66; B60L 2200/22; B60L 2210/40

(57) ABSTRACT

Service vehicles, such as compact service carts (e.g., compact electric vehicles), are described that support a variety of service applications. One such vehicle (100) generally includes a vehicle platform (102) and a service box (104). The vendor box (104) includes canopy doors (106) for each of the sides (110, 112, and 114). The canopy doors (106) are movable between a closed position, where the canopy door (106) encloses the service area (108), and an open position where the canopy doors (106) extend outwardly from the sides 110, 112 and 114. In the open position, the doors (106) thus function as a canopy to provide shade at the service area 108 and maximize the space available for rendering services on the sides (110, 112 and 114) of the box (104). The inventive vehicles are adaptable to meet the needs of a wide variety of service applications including food and beverage applications, medical applications, and others.

### CROSS-REFERENCE TO RELATED APPLICATION

This application claims the benefit of U.S. Provisional Patent Application No. 63/210,273, entitled, “Service Carts for Food, Beverage, and Other Applications”, filed Jun. 14, 2021, the contents of which are hereby incorporated by reference in their entirety.

### FIELD OF THE INVENTION

The present invention relates generally to service carts, e.g., for food, beverage, and other applications and, in particular, to service carts with flexible configurations and application adaptable power supplies and environmental control.

### BACKGROUND OF THE INVENTION

Service vehicles, such as food and beverage trucks, retail trucks or trailers, and the like, are used in many contexts. For example, service vehicles may be used to provide services in connection with events such as concerts, sporting events, festivals, or other one-time or recurring events. Service vehicles may also be used to provide peak-time service support, for example, for lunch service in office parks, rush-hour services at crowded transit locations, or other venues where additional services are desirable to support high-volume time periods. Such vehicles are convenient to support such needs because they can be rapidly deployed where needed to provide a variety of services at reduced expense in relation to permanent facilities.

However, as the value of service vehicles has become recognized by an increasing array of service providers, the desired attributes of the vehicles have also expanded. Food trucks generally require cooking or baking equipment specific to the types of food served, breakfast/café trucks or trailers may have specific equipment and storage needs, and retail vehicles may prioritize product display space over equipment space. However, custom designing of purpose-specific vehicles from the ground up can be cost prohibitive.

### SUMMARY OF THE INVENTION

The present invention is directed to service vehicles, such as compact service carts (e.g., compact electric vehicles), that support a variety of service applications. Such applications include food and beverage service, retail services, and medical applications including testing and vaccination. The physical structure of the vehicles is designed to accommodate different applications and can be readily configured for such applications. In addition, the vehicles provide power for various types of equipment and configurable compartments with independent environmental controls. The vehicles of the present invention can therefore be deployed in a variety of settings to meet a variety of service applications.

In accordance with one aspect of the present invention, a service vehicle and associated functionality is provided that involves separate electrical storage or batteries for the vehicle platform and for the service box. The vehicle platform includes a drive system for the vehicle and support structure. The service box is supported on the vehicle support structure and houses service equipment for a given service environment. The inventive service vehicle further includes a first, portable electric storage unit, such as a battery, for powering the drive system of the vehicle platform and a second, portable electric storage unit for powering the service equipment of the service box. For example, the second storage unit may include a rechargeable battery dedicated to powering the equipment of the service box. In this manner, an appropriate storage unit can be selected depending on the application and the equipment can run without depleting the power source for the vehicle platform.

In a preferred implementation, the vehicle platform is electrically powered. Accordingly, the first storage unit may provide adequate power for powering the vehicle platform, for example, a service cart. It will be appreciated that an electrically powered cart has advantages for some service applications. An electrically powered cart is quiet in operation and can be operated in indoor environments such as sports venues, concert venues and convention centers without concerns regarding exhaust fumes. In addition, the vehicle platform is preferably dimensioned to operate in space limited environments and may be embodied, for example, in a compact cart.

In accordance with another aspect of the present invention, a service vehicle is provided with one or more canopy doors. In this regard, the vehicle may include a vehicle platform and a vendor box as generally discussed above. The vendor box includes a service area extending across a majority of a first of the box sides, e.g., the left side, the right side, or the backside. A canopy door extends across the service area where the canopy door is movable between a first position, where the canopy door encloses the service area of the service box, and a second position where the canopy door extends outwardly from the first side of the service box above the service area. Such a canopy door has several advantages. First, when the canopy door is opened, it is stowed out of the way so that the available service area of the service box is maximized. In addition, the canopy door provides a canopy for shading the service area when it is open. In preferred implementations, canopy doors may be provided on two sides, e.g., the left and right sides of the service box, or all three exposed sides of the service box, i.e., the left side, the right side, and the back side.

In accordance with a still further aspect of the present invention, a service vehicle is provided with service compartments that have independently controllable environments. Service vehicles may be utilized a variety of applications including food and beverage services, retail services, and medical applications as noted above. In some of these applications, it is desirable to provide different environments within the service box. For example, in the context of a food and beverage vehicle, it may be desirable to provide refrigerated storage areas as well as heated or ambient temperature areas. Similarly, in medical contexts, it may be desirable to have refrigerated storage areas and freezer areas. Accordingly, a service vehicle may include a vehicle platform and a vendor box, as generally noted above, where the vendor box includes first and second compartments separated by at least one insulating partition connected to structure defining the vendor box. The vehicle may further include first and second temperature control elements, associated with the first and second compartments, for providing independent temperature control of the compartments of the vendor box. For example, the temperature control elements may include thermostats, vent controls, fans, compressors, heater elements and combinations thereof. The first and second environments may include other independent environmental controls such as humidity controls, pressure controls and the like.

As will be discussed in more detail below, a variety of vehicle configurations are provided for different service vehicle applications. Examples of these applications include a mobile retail outlet, a pizza cart including a wood burning oven, a portable commercial grill, a beverage cart with taps for dispensing various drinks, a portable bar, a portable café and breakfast service cart, a portable lunch service cart, a portable ice cream cart and others. These various applications can be supported by flexible physical configurations, independent temperature-controlled compartments, and flexible power supplies.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a schematic diagram of a service cart in accordance with one embodiment of the present invention;

FIG. 2 is a schematic diagram of a service cart in accordance with another embodiment of the present invention;

FIG. 3 is a schematic diagram of an electrical system of a service cart in accordance with the present invention;

FIG. 4 is a schematic diagram of temperature-controlled compartments of a service cart in accordance with the present invention; and

FIGS. 5A-5T show service carts configured for a variety of applications in accordance with the present invention.

### DETAILED DESCRIPTION OF THE INVENTION

In the following description, the invention is set forth in the context of various embodiments of all-electric service carts. In addition, examples of configurations for the service carts are provided in relation to various service cart applications. While these are particularly advantageous implementations and applications of the present invention, the invention is not limited to these embodiments or applications. Accordingly, the following description should be understood as exemplary and not by way of limitation.

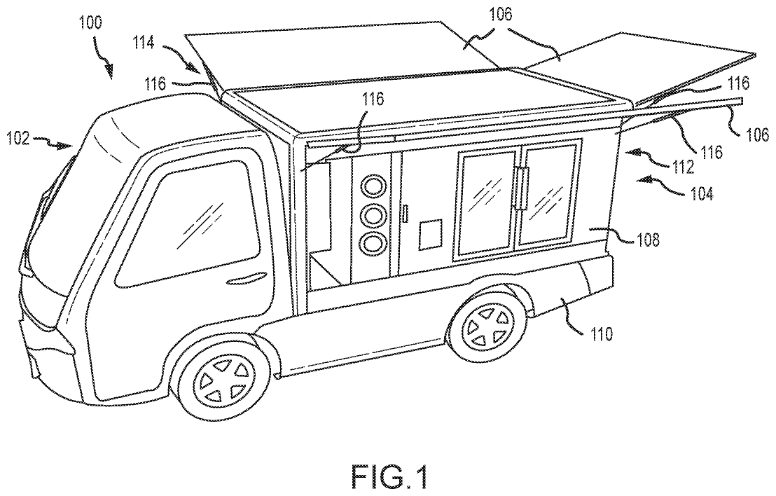

FIG. 1 illustrates a service vehicle 100 in accordance with an embodiment of the present invention. The illustrated vehicle 100 generally includes a vehicle platform 102 and a service box 104. The vehicle platform 102 provides the mobile functionality and may include a passenger compartment, a motor, wheels, support structure for supporting the vendor box 104, and a variety of other components for mobile vehicle functionality. The vendor box 104 includes work and display spaces, equipment for rendering a variety of vendor services, and supporting infrastructure as will be discussed in more detail below.

The illustrated vendor box 104 includes a right side 110, back side 112, and a left side, generally indicated by arrow 114, that may all be utilized for rendering vendor services. That is, any or all of the sides 110, 112, and 114 may be open and available for providing services. In certain cases, however, less than all of the sides 110, 112, and 114 may be utilized, for example, due to limitations in available space or personnel. One or more of the sides 110, 112 and 114 may include a service area 108 for supporting food, beverage, or other (e.g., medical services such as Covid 19 or other testing or vaccinations) services. The service area 108 may include equipment such as drink dispensers, refrigerators for food storage, display racks, surfaces for cooking equipment, or the like. Generally, the service area 108 may extend across a majority of a length and height of a side 110, 112, or 114 of the vendor box 104, and the size of the service area 108 is preferably maximized in relation to the dimensions of the side 110, 112 or 114.

The vendor box 104 preferably includes at least one canopy door 106. The illustrated vendor box 104 includes canopy doors 106 for each of the sides 110, 112, and 114. The canopy doors 106 are movable between a closed position, where the canopy door 106 encloses the service area 108, and an open position where the canopy doors extend outwardly from the sides 110, 112 and 114. In the open position, the doors 106 thus function as a canopy to provide shade at the service area 108. In the open position, the doors 106 may be disposed at an angle of between about −30 to 30 degrees relative to horizontal, for example, between about 10-20 degrees relative to horizontal. This angle may be adjustable to optimize shading or protection against the elements as well as to provide clearance for people to move underneath the doors 106 without obstruction. It will be appreciated that the canopy doors 106 are also out of the way in the open configuration so as to maximize the space available for rendering services on the sides 110, 112 and 114 of the box 104. In this regard, the doors 106 may be mounted on the box 104 by hinges such that the doors pivot between the closed and open positions. The hinges may be located at or near the top of the vehicle 100. Alternatively, the doors 106 translate and rotate between the closed and open positions. Preferably, the doors 106 can be securely retained in the open position, for example, due to counter-weighting or mechanical retention mechanisms such as pins, detents, or the like. Optionally, support posts may be provided to prop up the doors 106. In the illustrated embodiment, the doors 106 are raised and lowered, and held in the open position, by pneumatic cylinders 116.

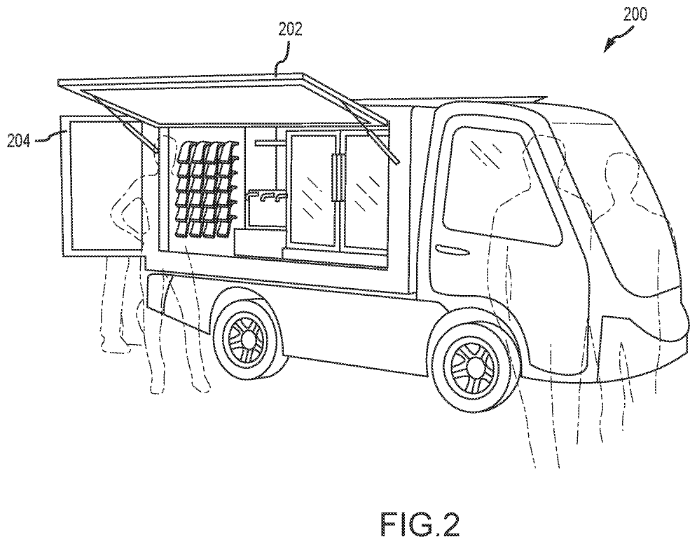

FIG. 2 shows an alternative configuration of a service vehicle 200 and accordance with the present invention. The vehicle 200 is generally similar to the vehicle 100 of FIG. 1, except the illustrated vehicle 200 includes canopy doors 202 only on the left and right sides of the vehicle 200, with vertically hinged doors 204, e.g., double doors, on the back side of the vehicle 200. Such vertically hinged doors may be preferred for certain applications, for example, where services are generally rendered from the left and/or right sides and the back side is accessed for storage, cleaning, or other purposes.

As will be described below, the vehicles as described above can be configured for a variety of services including food and beverage applications, medical applications and other applications. In particular, the vehicles defined base models that can be configured with optional service packages or custom configurations to suit the needs of a particular service application or customer. These configuration options include, in addition to the door configurations described above, equipment options, storage options, product display options, separate compartments with independent environmental controls, and other options. The vehicles may thus be understood as providing a base vehicle with flexible infrastructure support systems suitable for a variety of needs.

With regard to the vehicle itself, the overall dimensions of the vehicle, the power source (e.g., internal combustion or fully electric drive), road worthiness (top speed, compliance with local regulations) and other characteristics can vary depending on the application. The illustrated vehicles have a number of preferred attributes. With regard to dimension, the vehicles are preferably compact carts rather than full-size food trucks. In this regard, typical food trucks may be over 15 feet long, e.g., 18 to 24 feet long. Food trucks may be over 6 feet wide, e.g., 7 to 9 feet wide, and may be over 7 feet tall, e.g., 8 to 10 feet tall. Such food trucks are difficult or impossible to use in certain service environments of interest, e.g., to fit through doors of convention centers or sports venues or to drive on golf course cart paths or corridors of certain venues.

Accordingly, the illustrated vehicles are dimensioned as compact carts. That is, the widths of the vehicles are preferably no more than about 6 feet, the height is preferably no more than about 7 feet, and the length is preferably no more than about 15 feet, all with the vehicle doors closed. More specifically, the illustrated carts have a width of between about 4 to 5 feet, for example, about 55 inches; a length of between about 10 to 14 feet, for example, about 146 inches, and a height of between about 5 to 7 feet, for example, about 75 inches (all with the doors closed). These dimensions allow the vehicle to fit through many event center doorways, navigate many narrow corridors, and navigate many golf cart paths and park sidewalks.

The service vehicles of the present invention may be powered electrically or by internal combustion engines. However, the drive system of the vehicle platform is preferably powered by electric motors. Electric power allows the vehicles to be operated safely in indoor environments such as certain sports venues and convention centers. In addition, electrically powered vehicles are quiet for operation on golf courses and in indoor venues without unduly interfering with the enjoyment of games or events by patrons.

The vehicle may be designed to be transported to venue sites on a truck or trailer or may be designed so that they can be driven on roads. If the vehicles can be driven to venues, some flexibility is provided in design due to relief from regulatory requirements. However, in some service contexts, it is desirable to be able to use streets to move the vehicles to and between service sites. The illustrated vehicles are fully street legal, at least for driving on surface roads, and can reach speeds of at least about 25 mph, and preferably have a range of at least about 50 miles. This allows the vehicles to be conveniently deployed where needed and moved as desired, e.g., to successive high traffic areas.

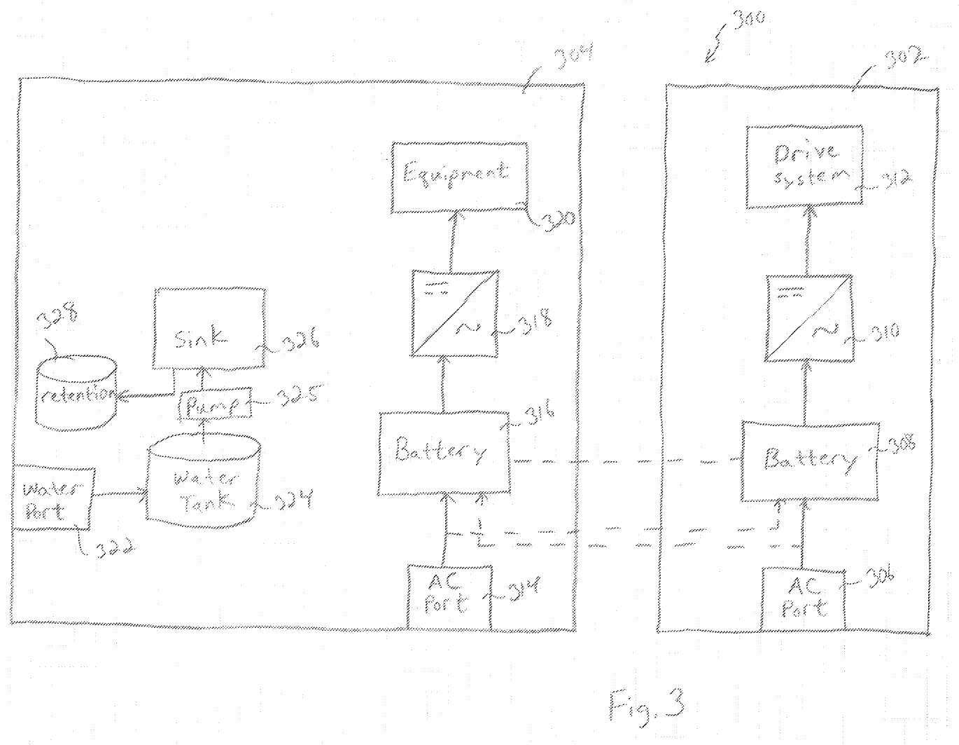

FIG. 3 is a block diagram illustrating an infrastructure 300 of a service vehicle in accordance with the present invention. Certain components of the infrastructure 300, e.g., the electric power supply, may be shared between the vehicle platform and the vendor box or may be provided separately. In the illustrated example, separate electrical power is provided to vehicle platform 302 and a vendor box 304, e.g., matched to the needs of the customer and application. Moreover, this allows the power system of the vendor box 304 to be fully utilized, for example, to run vendor equipment, without concern about draining the power resources of the vehicle platform 302 such that the vehicle 300 may not be able to make it back to a storage location or recharging center.

The power system of the vehicle platform 302 includes an alternating current power port 306, a battery 308, a controller 310, and a drive system 312. The AC port 306 allows the vehicle platform 302 to be plugged into an AC power source for recharging the battery 308. The battery 308, as noted above, preferably provides storage sufficient to provide a range of at least about 50 miles for the vehicle 300. For example, the battery 308 may be a rechargeable, lithium-based battery. A battery with a greater storage capacity may be utilized for applications where a greater range is necessary. The controller 310 converts DC power from the battery 308 into AC power for driving the drive system 312. The drive system 312, as noted above, is designed to provide a maximum speed of at least about 25 mph which is generally sufficient for use on surface roads as well as moving between locations at a sports venue, convention center or park.

Similarly, the power system of the vendor box 304 includes an AC power port 314, a battery 316, an inverter 318, and equipment 320. The AC port 314 and battery 16 are generally similar to those described in connection with the vehicle platform 302 and the inverter 318 performs functions similar to the controller described above. However, the battery 316 of the vendor box 304 may have attributes matched to the needs of a particular customer or application. For example, a customer may have the option to select between different battery choices, e.g., a 5 kWH battery, a 10 kWH battery or a 15 kWH battery. It will be appreciated that some service applications are more power intensive than others. In addition, some service applications may require that the vehicle 300 is deployed in the field for longer periods of time between rechargings than other service applications. The noted battery options are suitable for a wide array of service applications and allow customers to match needs and costs to their service environments. The AC port may also be used to directly power equipment when available at a service site. As will be described in more detail below, the equipment 320 is generally application-specific but may include lighting, refrigerators, toaster ovens, freezers, and a variety of other equipment.

As noted above, it is useful to have separate electrical power systems for the vehicle platform 302 and the vendor box 304. However, for certain applications, for example, low power service environments, it may be sufficient to run the vendor box 304 off of the power supply of the vehicle platform 302. Additionally, or alternatively, it may be convenient to recharge the batteries 308 and 316 of the vehicle platform 302 and vendor box 304 from a single AC port 306. Moreover, in some cases, it may be useful to electrically interconnect batteries 308 and 316 so that, for example, power from the battery 308 may be accessed by the vendor box 304 when needed or power from the vendor box 304 may be accessed to help the vehicle return to a storage or recharging location. Accordingly, as shown, optional connections may be provided between the batteries and 316 and the AC ports 306 and 314 of the vehicle platform 302 and the vendor box 304. Such connections may be activated manually, via a manual switch, or automatically, e.g., via a switch that activates based on a monitored battery charge level or a monitored electrical signal. The system may be set to prefer to use power from battery 308 or 316, for example, depending on what the load is (e.g., the drive system 312 or equipment 320) or preferences set by the user.

For certain service applications, it is desirable to have a water supply. Such a water supply may be used for cleaning glassware, cleaning serving articles, washing hands, and cleaning food items, among other things. The illustrated vendor box 304 includes a water port 322, a clean water tank 324, a pump 325, a sink 326, and a water retention basin 328. The water port 322 allows water from a source such as a hose to be connected to the vendor box 304, e.g., to fill the water tank 324 or directly provide water to the sink 326 or other water device. The water tank 324 preferably has a storage capacity sufficient to satisfy the water requirements of a service event in cases where an on-site water supplies not available. For example, the water tank 324 may have a storage capacity of at least about 10 gallons. The pump 325 pumps water from the tank 324 for use at the sink 326 or another water device. Finally, water from the sink 326 drains to a dirty water retention basin 328.

The capacity of the retention basin 328 may be the same as or slightly greater than the water tank 324.

For certain service applications, it may be desirable to have separate compartments of a vendor box with independent environmental controls. Most commonly, it is desirable to have separate temperature controls, e.g., for refrigerated compartments, freezer compartments, ambient temperature work areas, heated compartments (e.g., for keeping food warm) and the like. However, other environmental factors may be independently controlled such as humidity and pressure. FIG. 4 illustrates a vehicle 400 with a number of compartments 402, 404, 406 and 408, that may have independent environmental controls such as temperature controls. As shown, the compartments may divide up the volume of the vendor box into horizontally side-by-side compartments, vertically stacked compartments, or any useful combination thereof. In the case of independent temperature controls, the various compartments 402, 404, 406 and 408 may include fans, compressors, heater elements, vents and other elements for independently controlling temperature. The temperature in the various compartments may be controlled via one or more thermostats and an appropriate control panel may be provided to set the desired temperatures. To facilitate independent temperature control, the walls or partitions separating the various compartments 402, 404, 406 and 408 may be formed from insulating materials or provided with a laminated insulating material.

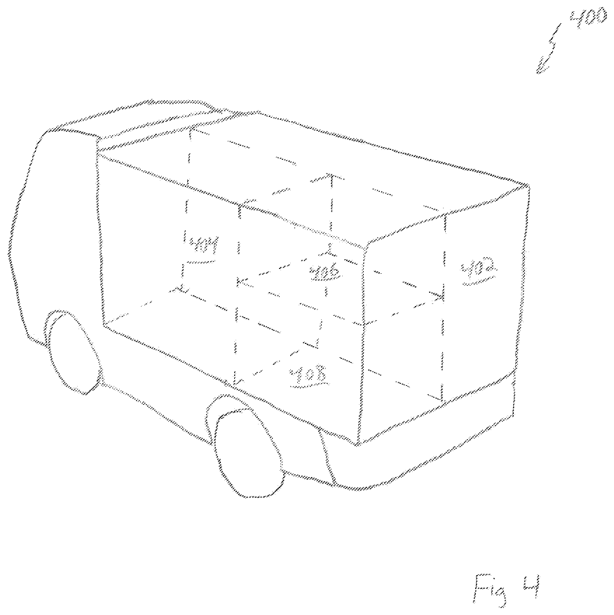

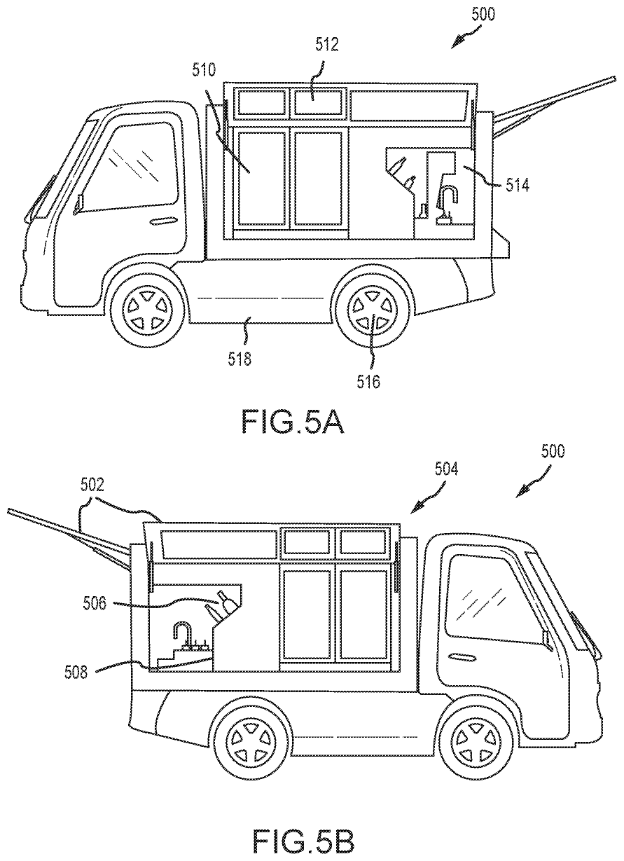

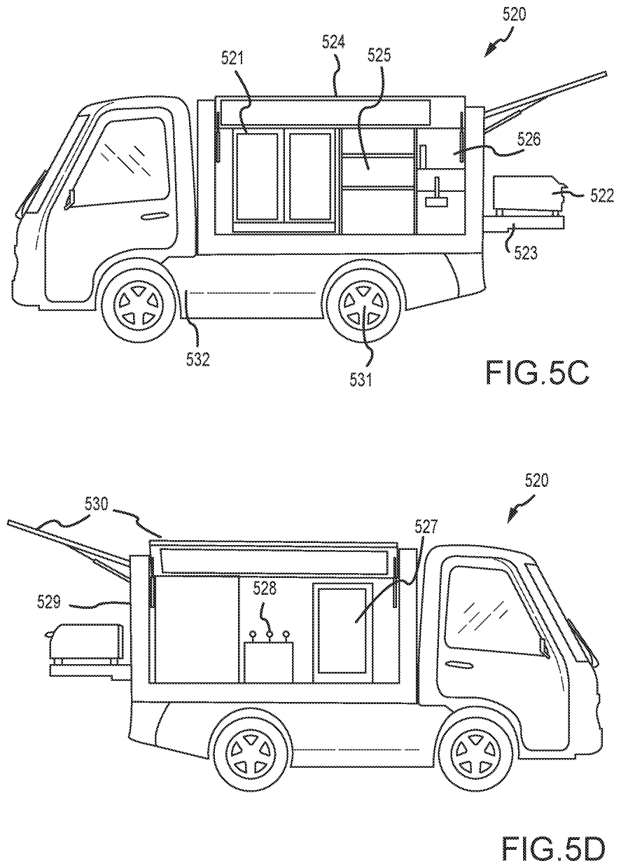

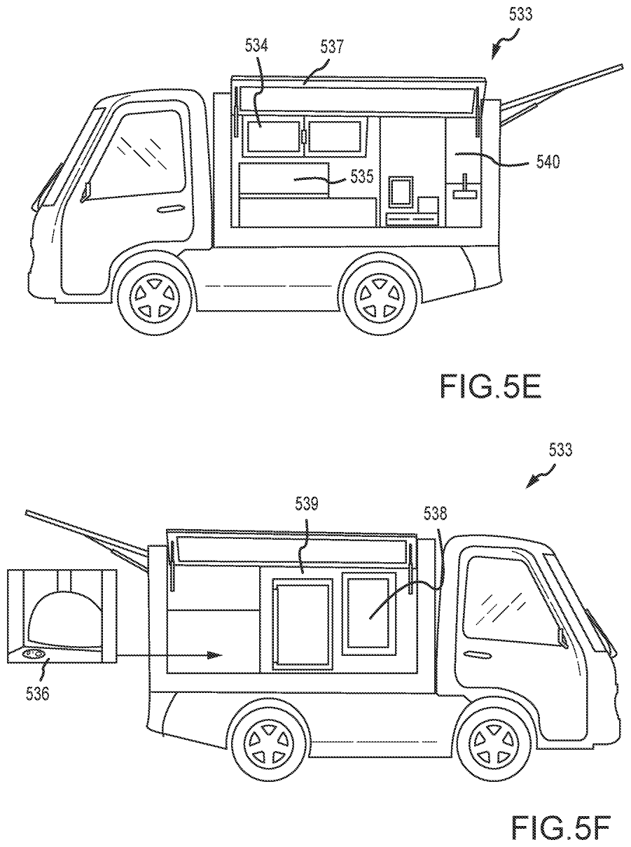

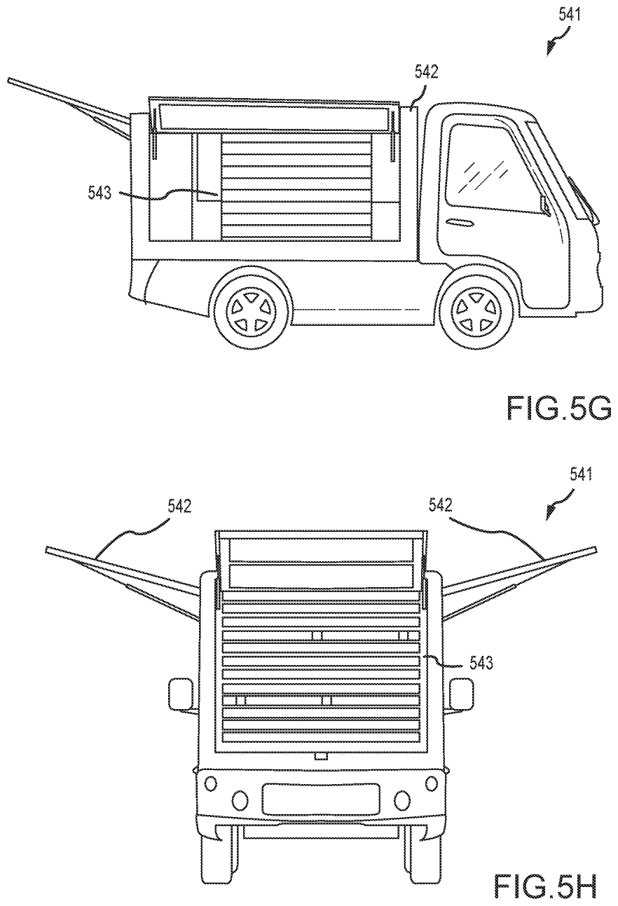

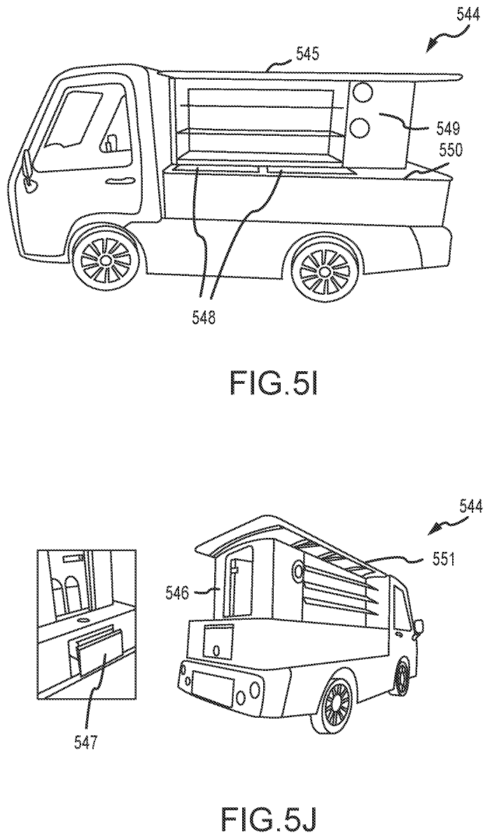

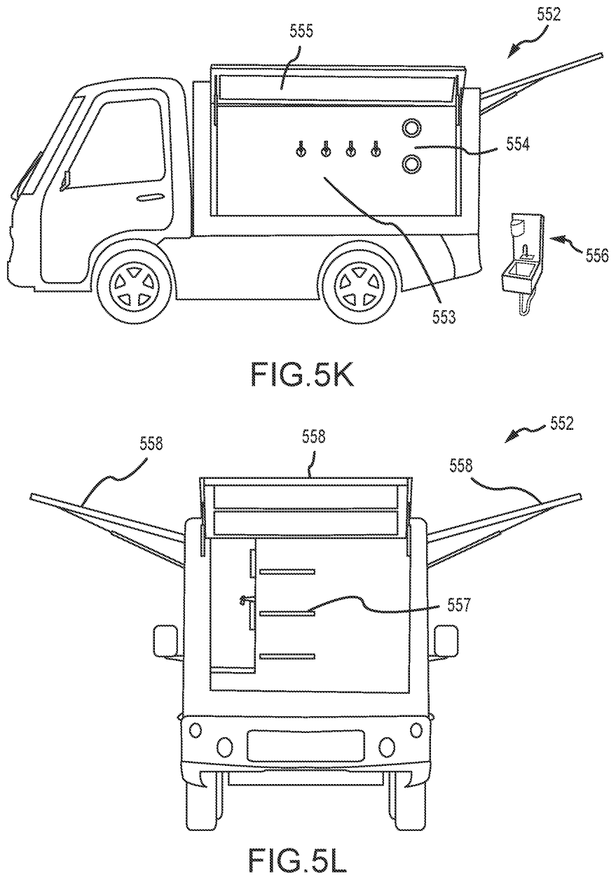

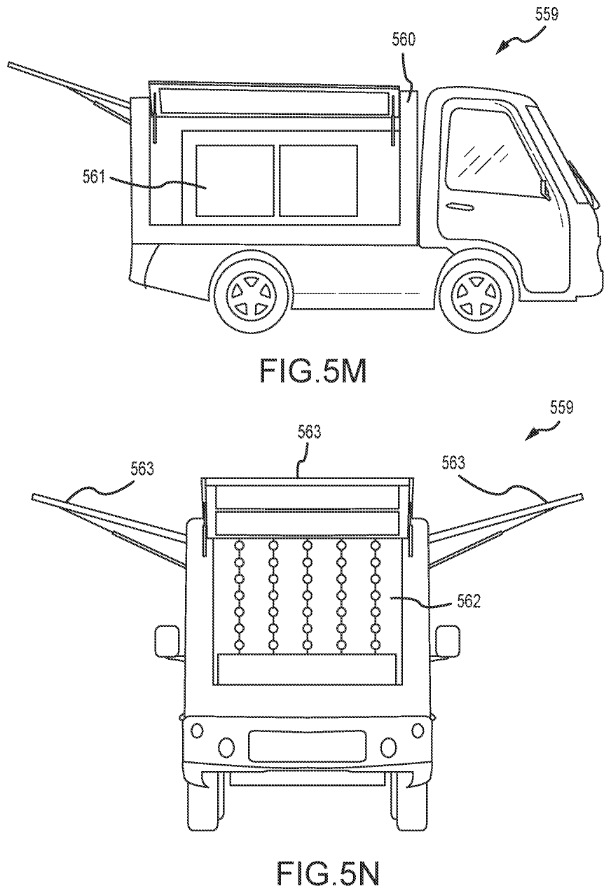

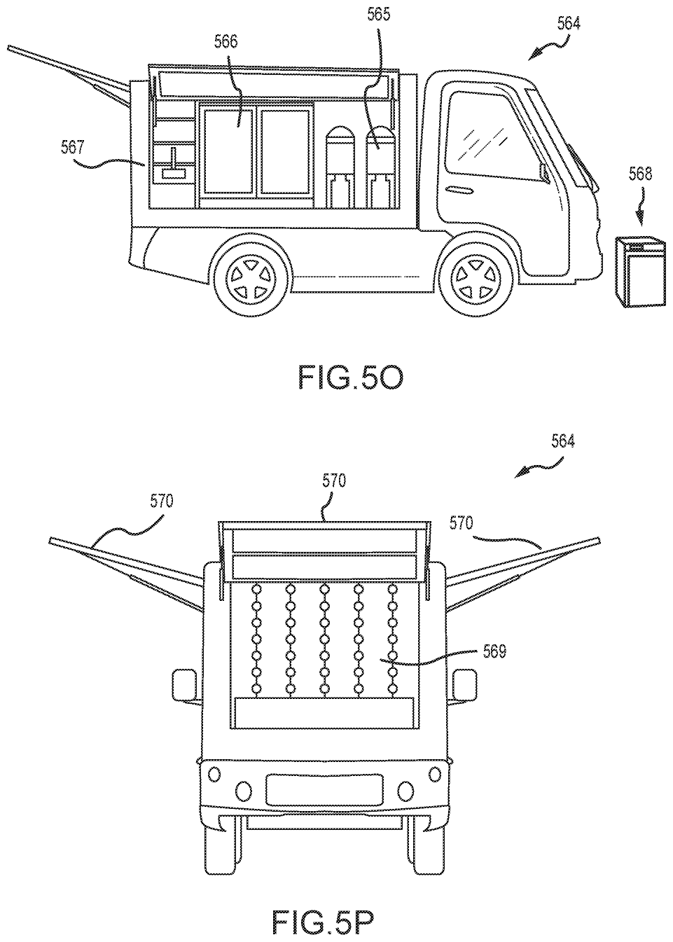

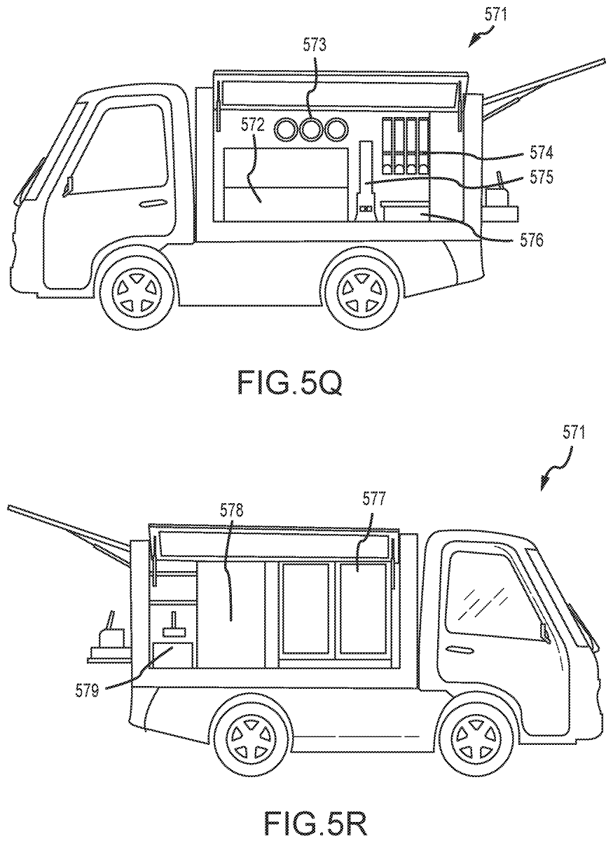

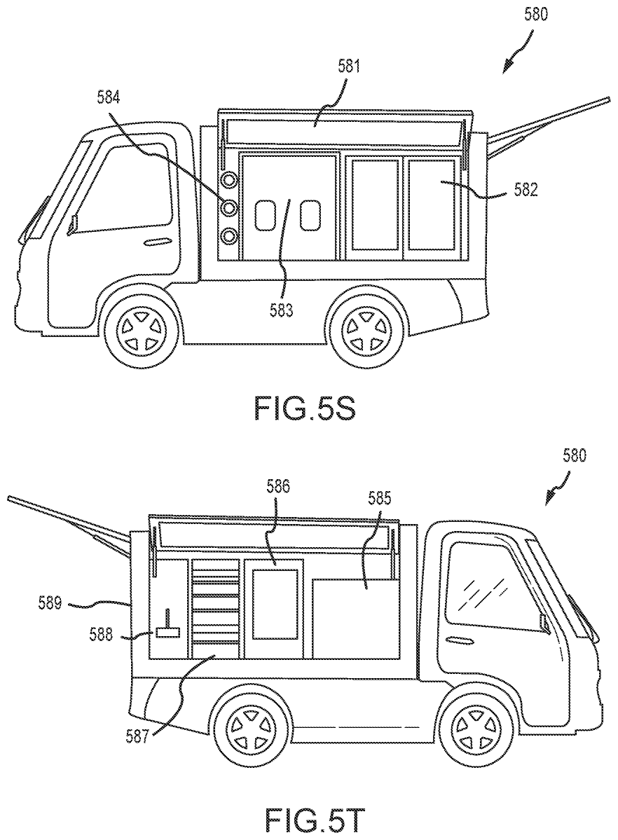

As noted above, the vehicles of the present invention are adaptable to meet the needs of a wide variety of service applications. These include food and beverage applications, medical applications and others. FIGS. 5A-5T illustrate a number of these applications. Referring to FIGS. 5A-5B, a vehicle 500 is shown that is adapted for certain mobile bar applications. A mobile bar may be desired for a variety of social and networking events such as weddings, conferences and other events. The illustrated vehicle 500 includes three canopy doors 502 that can be closed for transportation purposes and opened to provide access to service areas and provide shading. The service box 504 of the vehicle 500 in the illustrated embodiment includes a custom two-tier bar and may also include an optional small cigar humidor 508. The box 504 further includes a double door refrigerator for storing canned or bottled beverages, a powered vendor box 512, for example, for storing supplies to restock the bar 506 and a mobile hand sink 514 for washing glassware, hands, garnish items in the like. The illustrated vehicle 500 further includes alloy wheels 516 and panels 518 that may display customer specific graphics.

FIGS. 5C-D illustrate a vehicle 520 configured to function as a mobile grill and lunch cart. The illustrated vehicle 520 includes a double door refrigerator 521 for storing cold items such as drinks and a full-size, gas-powered flattop grill 522 disposed on an extending grill shelf 523 for grilling hamburger patties, hotdogs, chicken, and the like. The right side of the vehicle 520 may further include a powered vendor box 524 for cold storage, a two-shelf prep area 525 and a mobile hand sink 526. The opposite side of the vendor box may include an additional single door refrigerator 527 and three pump condiment dispensers 528. The back side of the vendor box may further include two chip clip displays 529. Finally, the illustrated vehicle 520 may include three canopy doors 530, alloy wheels 531 and external panels 532 that may be decorated with customer specific graphics. Customer specific graphics may also be provided on internal surfaces that are visible when the doors 530 are opened.

FIGS. 5E-5F illustrate a vehicle 533 that may be configured as a portable pizza cart. In this regard, the cart may include a pizza dough cabinet 534, a refrigerated prep table 535 for preparing pizzas to order, and a woodfired pizza oven 536 for baking pizzas on location. The vehicle 533 may also include a powered vendor box 537 for storing supplies, a single door refrigerator 538 for storing drinks and/or ingredients, a hot cold storage box 539 for keeping pizzas or pizza slices warm until served and a mobile hand sink 540. As noted above, exterior and/or interior panels of the vehicle 533 may be decorated with customer specific graphics.

FIGS. 5G-5H show a vehicle 541 configured as a retail cart, for example, for displaying and selling clothing items, gift items and the like. In this example, the vendor box 542 may be nonpowered or may have power for lighting, cash terminals and the like. In the case where the box 542 is unpowered, lighting, cash boxes and other equipment may be self-powered. As shown, the vehicle 541 includes three canopy doors and adjustable track walls on some or all of the exposed sides of the vendor box 542. As will be understood, such adjustable track walls 543 allow for display of a variety of merchandise by way of various hook mechanisms that can be conveniently positioned on the track walls as needed.

FIGS. 5I-5J illustrates a vehicle 544 configured as a club cart for use on golf courses or other locations. The vehicle 544 includes a large display case for displaying a variety of food products or merchandise. The back side of the vehicle 544 includes a service area 546 that easily transitions for all-day use. In this regard, the service area 546 can support two coffee pots for dispensing coffee for morning use as well as ice and drink tanks to keep beverages cold later in the day. The back side may also include a refuse bin 547. The right side of the vehicle 544 may include two large locking cold storage bins 548 for cold beverage and/or refrigerated food items and clean ice storage bins 550. The vehicle 544 also includes multiple cup dispensers 549 and may further include a fabric awning 551 that may be provided in various color and pattern options.

FIGS. 5K-5L show a vehicle 552 configured as a tap cart for dispensing beverages such as wine or beer. As shown, the vehicle 552 includes a number of beverage taps 553 on the left and/or right sides thereof. Although not shown, it will be appreciated that beverage tanks/cannisters and pressure cannisters may be disposed in an interior portion of a vendor box of the vehicle 552. The illustrated vehicle 552 further includes cup dispensers 554 and a powered vendor box 555 for storing cold supplies such as additional canisters. The backside of the vehicle provides access to a mobile hand sink 556 and storage shelves 557. As shown, the vehicle 552 includes three canopy doors 558.

FIGS. 5M-5N show a vehicle 559 configured as a snack cart. The illustrated vehicle 559 includes a powered vendor box 560 that may include a double-sided refrigerator 561. The backside of the vehicle 559 includes a storage area 562 which may be configured, for example, with columns of chip clips. Again, the vehicle 559 includes three canopy doors 563.

FIGS. 5O-5P show a still further alternative configuration of a vehicle as a cafe/breakfast cart. The right and/or left sides of the vehicle 564 include a service area that may support insulated air pot dispensers and a double door refrigerator, e.g., for cold beverage and food storage. At least one of the sides of the vehicle 564 may also include a mobile hand sink 567. In addition, at least one of the sides of the vehicle 564 may include a heated food hold 568 for keeping food items warm. The backside of the vehicle 564 may include columns of chip clips 569. The illustrated vehicle 564 further includes three canopy doors 570.

FIGS. 5Q-5R show a vehicle 571 configured as an ice cream cart. The right side of the illustrated vehicle 571 includes an ice cream freezer unit 572, three cup dispensers 573, four topping dispensers 574, an ice cream cone dispenser 575 and a heated dipper well 576. The left side of the illustrated vehicle 571 includes a double door refrigerator 577, a single door freezer unit 578 and a mobile hand sink 579. The backside of the vehicle 571 may include a retractable shelf for supporting additional workspace and topping containers including, for example, heated hot fudge or caramel dispensers.

FIGS. 5S-5T show a further exemplary configuration of a vehicle 580 in accordance with the present invention. In this case, the vehicle 580 is configured as a cafe/breakfast cart with hot food options. The right side of the illustrated vehicle 580 includes a powered vendor box 581 for hot and/or cold storage, a double refrigerator 582 for storing cold beverage and food items, double insulated carafes 583 for dispensing coffee or other hot beverages, and three cup dispensers 584.

The left side of the illustrated vehicle 580 includes a hot/cold storage container 585, a single door refrigerator 586, four storage shelves 587 and a mobile hand sink 588. The backside of the vehicle 580 may include a number of chip clips 589. Additionally, or alternatively, the backside of the vehicle 580 may include a retractable shelf for supporting a toaster oven for toasting bagels and other items or for providing customer space for adding creamers, sugar, insulating sleeves, stoppers and the like.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A service vehicle, comprising:
a vehicle platform including wheels, a drive system, and support structure;
a service box, supported on said support structure, for housing service equipment for a given service environment;
a first, portable electric storage unit, for powering said drive system of said vehicle platform; and
a second, portable electric storage unit, separate from said first electric storage unit, for powering said service equipment of said service box.

2. The service vehicle of claim 1, wherein said vehicle platform comprises an electrically powered drivetrain.

3. The service vehicle of claim 1, wherein said service vehicle comprises a compact cart.

4. The service vehicle of claim 3, wherein said compact cart has a width of no more than about 5 feet.

5. The service vehicle of claim 3, wherein said compact cart has a length of no more than about 15 feet.

6. The service vehicle of claim 1, wherein said second electric storage unit comprises a rechargeable battery.

7. The service vehicle of claim 6, wherein said rechargeable battery has a storage capacity of at least about 5 kWH.

8. The service vehicle of claim 6, wherein said rechargeable battery has a storage capacity of at least about 10 kWH.

9. The service vehicle of claim 1, further comprising an alternating current power port.

10. The service vehicle of claim 1, further comprising a controller, disposed between said second electric storage unit and said service equipment, for converting DC power from said second electric storage unit into AC power for said service equipment.

11-22. (canceled)

23. A method for operating a service vehicle, comprising:
providing a vehicle platform including wheels, a drive system, and support structure;
providing a service box, supported on said support structure, for housing service equipment for a given service environment;
powering said drive system of said vehicle platform using a first, portable electric storage unit; and
powering said service equipment of said service box using a second, portable electric storage unit, separate from said first electric storage unit.

24. The method of claim 23, wherein said vehicle platform comprises an electrically powered drivetrain.

25. The method of claim 23, wherein said service vehicle comprises a compact cart.

26. The service vehicle of claim 25, wherein said compact cart has a width of no more than about 5 feet.

27. The method of claim 25, wherein said compact cart has a length of no more than about 15 feet.

28. The method of claim 23, wherein said second electric storage unit comprises a rechargeable battery and said method comprises connecting said rechargeable battery to a recharging power source.

29. The method of claim 28, wherein said rechargeable battery has a storage capacity of at least about 5 kWH.

30. The method of claim 28, wherein said rechargeable battery has a storage capacity of at least about 10 kWH.

31. The method of claim 28, further comprising connecting said rechargeable battery to an AC power source via an alternating current power port.

32. The method of claim 23, further comprising operating a controller, disposed between said second electric storage unit and said service equipment, for converting DC power from said second electric storage unit into AC power for said service equipment.
